(19) United States
(12) Patent Application Publication
(10) Pub. No.: US 2011/0100010 A1
(43) Pub. Date: May 5, 2011

(54) ADIABATIC COMPRESSED AIR ENERGY STORAGE SYSTEM WITH LIQUID THERMAL ENERGY STORAGE

(76) Inventors: Sebastian W. Freund, Unterfohring (DE); Matthias Finkenrath, Garaching b. Muenchen (DE); Cristina Botero, Cambridge, MA (US); Clarissa S.K. Belloni, Oxford (GB); Miguel Angel Gonzalez Salazar, Munchen (DE); Stephanie Marie-Noelle Hoffmann, Muenchen (DE)

(21) Appl. No.: 12/609,449

(22) Filed: Oct. 30, 2009

(51) Int. Cl. F02C 6/16; F02C 1/05; F02C 6/02; F01K 23/16; F01K 23/18

(52) U.S. Cl. 60/659; 60/652; 60/682; 60/650; 165/10; 60/663; 60/716; 60/719

(57) ABSTRACT

An adiabatic compressed air energy storage (ACAES) system includes a compressor system, an air storage unit, and a turbine system. The ACAES system further includes a thermal energy storage (TES) system that includes a container, a plurality of heat exchangers, a liquid TES medium conduit system fluidly coupling the container to the plurality of heat exchangers, and a liquid TES medium stored within the container. The TES system also includes a plurality of pumps coupled to the liquid TES medium conduit system and configured to transport the liquid TES medium between the plurality of heat exchangers and the container, and a thermal separation system positioned within the container configured to thermally isolate a first portion of the liquid TES medium at a lower temperature from a second portion of the liquid TES medium at a higher temperature.

### BACKGROUND OF THE INVENTION

Embodiments of the invention relate generally to compressed air energy storage (CAES) systems and, more particularly, to a multi-stage thermal energy storage (TES) system in an adiabatic CAES system.

Air compression and expansion systems are used in a multitude of industries for a variety of applications. For example, one such application is the use of air compression and expansion systems for storing energy. Compressed air energy storage (CAES) systems typically include a compression train having a plurality of compressors that compress intake air and provide the compressed intake air to a cavern, underground storage, or other compressed air storage component. The compressed air is then later used to drive turbines to produce electrical energy. During operation of the compression stage of a CAES system, the compressed intake air is typically cooled. During operation of the expansion stage, air is discharged from underground storage through heaters and turbines and expands such that the air exits the turbines at ambient pressure.

Typically, compressors and turbines in CAES systems are each connected to a generator/motor device through respective clutches, permitting operation either solely of the compressors or solely of the turbines during appropriate selected time periods. During off-peak periods of electricity demand in the power grid (i.e., nights and weekends), the compressor train is driven through its clutch by the generator/motor. In this scheme, the generator/motor functions as a motor, drawing power from a power grid. The compressed air is then cooled and delivered to underground storage. During peak demand periods, with the turbine clutch engaged, air is withdrawn from storage and then heated and expanded through a turbine train to provide power by driving the generator/motor. In this scheme, the generator/motor functions as a generator, providing power to a power grid, for example.

One specific type of CAES system that has been proposed is an adiabatic compressed air energy storage system (ACAES), in which thermal energy storage (TES) unit(s) are employed to cool the compressed air prior to storage in the cavern and to reheat the air when it is withdrawn from the cavern and supplied to the turbine train. ACAES systems thus allow for storing energy with higher efficiency than non-adiabatic systems, since the heat generated during the air compression is not disposed of but used subsequently to preheat the compressed air during discharge through a turbine.

Currently proposed ACAES system designs typically incorporate a single TES unit. The use of a single TES unit results in the TES unit being forced to operate at a high temperature and high pressure. For example, a single TES unit may reach operating temperatures as high as 650° Celsius and at a pressure of 60 bar. The high temperature, high pressure, and large duty of the TES unit pose engineering challenges with regard to material, thermal expansion, heat losses, size and mechanical stresses. The need to address these engineering challenges leads to increased cost and long development times and presents a steep market barrier.

Additionally, the use of a single TES unit also results in decreased efficiency of the ACAES system. That is, turbomachinery (i.e., compressors and turbines) forced to operate at a high temperature and a high pressure ratio has a lower efficiency, as compared to turbomachinery that operates at a lower temperatures and pressure ratios. An arrangement where additional TES units are added between stages of the compressors and turbines functions to lower temperature and pressure ratios, thus helping increase the efficiency of the turbomachinery in the ACAES system.

An ACAES system implementing two TES units has been proposed by the German Aerospace Center (DLR); however, such an arrangement of two TES units still does not completely address the issues of temperature and pressure. That is, even with a reduction in temperature and pressure provided by the use of two TES units, the TES units are still forced to operate at temperatures around 500° Celsius. The presence of such high temperatures of operation remains a substantial barrier for implementing ACAES systems in commercial operation.

Therefore, it would be desirable to design a system and method that overcomes the aforementioned drawbacks.

### BRIEF DESCRIPTION OF THE INVENTION

In accordance with one aspect of the invention, an adiabatic compressed air energy storage (ACAES) system includes a compressor system configured to compress air supplied thereto. The compressor system includes a plurality of compressors and a compressor conduit fluidly connecting the plurality of compressors together and having an air inlet and an air outlet. The ACAES system also includes an air storage unit connected to the air outlet of the compressor conduit and configured to store compressed air received from the compressor system, and a turbine system configured to expand compressed air supplied thereto from the air storage unit. The turbine system includes a plurality of turbines and a turbine conduit fluidly connecting the plurality of turbines together and having an air inlet and an air outlet. The ACAES system further includes a thermal energy storage (TES) system configured to remove thermal energy from compressed air passing through the compressor conduit and to return thermal energy to air passing through the turbine conduit. The TES system includes a container, a plurality of heat exchangers, a liquid TES medium conduit system fluidly coupling the container to the plurality of heat exchangers, and a liquid TES medium stored within the container. The TES system also includes a plurality of pumps coupled to the liquid TES medium conduit system and configured to transport the liquid TES medium between the plurality of heat exchangers and the container, and a thermal separation system positioned within the container configured to thermally isolate a first portion of the liquid TES medium at a lower temperature from a second portion of the liquid TES medium at a higher temperature.

In accordance with another aspect of the invention, a method for adiabatic compressed air energy storage (ACAES) includes supplying air to a compressor system, the compressor system including a plurality of compressor units fluidly connected by a compressor conduit. The method also includes compressing the air in the compressor system during a compression stage and storing the compressed air in a compressed air storage unit. The method also includes supplying the compressed air from the compressed air storage unit to a turbine system, the turbine system including a plurality of turbine units fluidly connected by a turbine conduit and expanding the air in the turbine system during an expansion stage. The method further includes, during each of the compression stage and the expansion stage, passing the air through a liquid thermal energy storage (TES) system coupled to each of the compressor conduit and the turbine conduit, the liquid TES system including a liquid storage volume, a plurality of heat exchangers fluidly coupled to the liquid storage volume, and a thermal separation unit configured to thermally isolate a liquid in the liquid storage volume on a first side of the thermal separation unit from a liquid in the liquid storage volume on a second side of the thermal separation unit.

In accordance with yet another aspect of the invention, an adiabatic compressed air energy storage (ACAES) system includes a compressor system configured to compress air supplied thereto, the compressor system including a plurality of compressors and a compressor conduit connecting the plurality of compressors and having an air inlet and an air outlet. The ACAES system also includes an air storage unit connected to the air outlet of the compressor conduit and configured to store compressed air received from the compressor system, and a turbine system configured to expand compressed air supplied thereto from the air storage unit. The turbine system includes a plurality of turbines and a turbine conduit connecting the plurality of turbines and having an air inlet and an air outlet. The ACAES system further includes a liquid thermal energy storage (TES) system comprising a TES liquid configured to remove thermal energy from compressed air passing through the compressor conduit and to return thermal energy to air passing through the turbine conduit, the liquid TES system further including a storage volume configured to store the TES liquid, a plurality of heat exchangers fluidly coupled to the storage volume, and a thermal separator positioned within the container and configured to thermally separate a hot volume of the TES liquid from a cold volume of the TES liquid within the storage volume.

Various other features and advantages will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a block schematic diagram of an adiabatic compressed air energy storage (ACAES) system according to an embodiment of the present invention.

### DETAILED DESCRIPTION

Embodiments of the invention provide a multi-stage ACAES system with a TES system. The multi-stage ACAES system preferably includes a two-stage compression/expansion system including a low pressure stage and a high pressure stage; however, embodiments of the invention may include more than two stages. The TES system preferably includes a liquid TES system having a heat exchanger for each stage of compression/expansion. The TES system also preferably includes a single tank holding a liquid TES medium that is simultaneously pumped through the heat exchangers during operation. The tank is preferably configured to separate a hot liquid TES medium therein from a cold liquid TES medium therein via a separation system that may include, for example, (1) stratification due to gravity and a system to prevent mixing and convection, (2) separation via a floating piston, or (3) having a thermocline and regenerative thermal storage with solid inventory material.

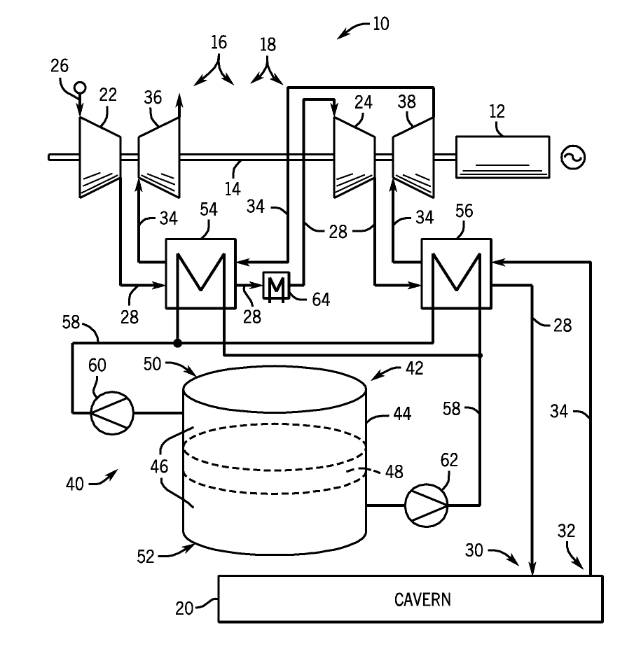

Referring now to FIG. 1, a block schematic diagram of an adiabatic compressed air energy storage (ACAES) system 10 is shown according to an embodiment of the invention.

ACAES system 10 includes a motor-generator unit 12 (which may be a combined unit or separate units), a drive shaft 14, a compressor system or train 16, a turbine system or train 18, and a compressed air storage volume or cavern 20. Cavern 20 may be, for example, a porous rock formation, a depleted natural gas/oil field, and a cavern in salt or rock formations. Alternatively, cavern 20 can be an above-ground system such as, for example, a high pressure pipeline similar to that used for conveying natural gas.

Motor-generator unit 12 is electrically connected to a power generating plant (not shown) to receive power therefrom. Motor-generator unit 12 and drive shaft 14 are selectively coupled to compressor system 16 and turbine system 18 through clutches (not shown). During a compression mode of operation, compressor system 16 is coupled to motor-generator unit 12 and drive shaft 14, while turbine system 18 is decoupled from the motor-generator unit 12 and drive shaft 14. During an expansion mode of operation, turbine system 18 is coupled to motor-generator unit 12 and drive shaft 14, while compressor system 16 is decoupled from the motor-generator unit 12 and drive shaft 14.

According to an embodiment of the invention, motor-generator unit 12 drives drive shaft 14 during the compression mode of operation (i.e., compression stage). In turn, drive shaft 14 drives compressor system 16, which includes a low pressure compressor 22 and a high pressure compressor 24, such that a quantity of ambient air enters an ambient air intake or inlet 26 and is compressed by the compressor system 16. Low pressure compressor 22 is coupled to high pressure compressor 24 via a compression path or conduit 28. According to the present embodiment, low pressure compressor 22 compresses the ambient air. The compressed ambient air then passes along compression path 28 to high pressure compressor 24, where the ambient air is further compressed before exiting the compression path 28 at a compression path outlet 30 and being transferred to cavern 20.

After compressed air is stored in cavern 20, compressed air can be allowed to enter an inlet 32 of an expansion path or turbine conduit 34 during the expansion mode of operation (i.e., expansion stage). The compressed air proceeds down the expansion path 34 to turbine system 18, which includes a low pressure turbine 36 and a high pressure turbine 38. Due to the configuration of turbine system 18, the compressed air is allowed to expand as it passes therethrough, thus, causing rotation of turbines 36, 38 of turbine system 18 so as to facilitate power generation. The rotation of turbine system 18 causes drive shaft 14 to rotate. In turn, drive shaft 14 drives motor-generator unit 12, causing the unit to function as a generator to produce electricity.

As shown in FIG. 1, ACAES system 10 also includes a multi-stage thermal energy storage (TES) system 40 configured to cool and heat the air passing through the compression and expansion paths 28, 34 as it is being compressed/expanded by the compressor and turbine systems 16, 18. The multi-stage TES system 40 includes a liquid TES unit 42 comprising a containment vessel 44, a liquid TES medium 46, and an optional thermal separator 48. The TES liquid 46 is a heat storage material of sufficient quantity to store the heat of compression generated during the compression cycle. In embodiments of the invention, TES liquid 46 is non-pressurized and may include liquids such as mineral oil, synthetic oil, molten salt, or the like.

Thermal separator 48 is designed to create a strong thermal gradient between a cold TES liquid 46 on one side thereof and a hot TES liquid 46 on another side thereof within containment vessel 44 and to reduce temperatures of TES liquid 46 within containment vessel 44 as close to a binary temperature system as possible. In this manner, hot TES liquid 46 in one end 50 of containment vessel 44 is thermally isolated from cold TES liquid 46 in another end 52 of containment vessel 44. In one embodiment, thermal separator 48 includes a material capable of storing heat and capable of thermally isolating the hot and cold TES liquid 46. In this embodiment, no other thermal separator 48 may be installed within containment vessel 44 to create a thermocline, and the material may include, for example, concrete, rocks, bricks, metal, or the like. In another embodiment, the thermal separator 48 includes a floating separator piston configured to separate the hot and the cold TES liquid 46. In this manner, as cold TES liquid 46 is removed from end 52 of containment vessel 44, the floating separator piston correspondingly lowers within containment vessel 44 while hot TES liquid 46 is added to containment vessel 44 at end 50, and vice-versa. The floating separator piston accordingly floats on the volume of cold TES liquid 46 and rises and falls therewith. In one embodiment, the floating separator piston may comprise metal, plastic or a composite thereof.

In yet another embodiment the thermal separator instead of a piston consist of a multitude of planar devices installed in the vessel and configured in a way to prevent convection and mixing of hot and cold liquid that stays separated due to its gravity difference.

Multi-stage TES system 40 includes a pair of heat exchangers 54, 56 fluidly coupled to TES liquid 46 in liquid TES unit 42 via a TES conduit system 58. TES conduit 58 couples heat exchangers 54, 56 together in a parallel mode such that the temperature of the TES liquid 46 entering each heat exchanger 54, 56 is substantially the same temperature and such that the temperature of the TES liquid 46 exiting each heat exchanger 54, 56 is substantially the same temperature. In one embodiment, heat exchanger 54 is a low pressure heat exchanger, and heat exchanger 56 is a high pressure heat exchanger. Heat exchangers 54, 56 are thermally coupled to compression path 28 and to expansion path 34. A hot-side pump 60 is configured pump hot TES liquid 46 from end 50 of containment vessel 44 through heat exchangers 54, 56 to end 52 of containment vessel 44. A cold-side pump 62 is configured pump cold TES liquid 46 from end 52 of containment vessel 44 through heat exchangers 54, 56 to end 50 of containment vessel 44.

In operation, multi-stage TES system 40 functions to remove heat from the compressed air during a compression or “charging” stage/mode of operation of ACAES system 10. As air is compressed by compressor system 16 and as it passes along compression path 28 to cavern 20, multi-stage TES system 40 cools the compressed air as described below. That is, before the compressed air is stored in cavern 20, it is passed through heat exchangers 54, 56 to remove heat from the compressed air prior to storage in the cavern, so as to protect the integrity thereof.

The heat that is stored by multi-stage TES system 40 in the hot TES liquid 46 is conveyed or transferred back to the compressed air during an expansion or “discharging” stage/mode of operation of ACAES system 10. As the compressed air is released from cavern 20 and passes through expansion path 34 to be expanded by turbine system 18, the air is heated as it passes back through multi-stage TES system 40 as described below.

According to the embodiment of FIG. 1, heat exchangers 54, 56 are positioned intermittently along the compression path 28 and the expansion path 34 to provide cooling/heating to air passing therethrough. Air is brought into compression path 28 through inlet 26 and provided to low pressure compressor 22 during the compression or “charging” stage/mode of operation of ACAES system 10. Low pressure compressor 22 compresses the air to a first pressure level (i.e., a “low” pressure) and to an increased temperature, and the air is then routed through compression path 28 to heat exchanger 54, where the air is cooled. To cool the compressed air in heat exchanger 54, cold-side pump 62 pumps cold TES liquid 46 from end 52 through heat exchanger 54 while the heated compressed air flows in a separate fluid path therethrough. The air then continues through compression path 28 to high pressure compressor 24, where the air is compressed to a second pressure level (i.e., a “high” pressure) and to an increased temperature. The air is then routed through compression path 28 to heat exchanger 56, where the air is again cooled before exiting compression path 28 through outlet 30 for storage in cavern 20. To cool the compressed air in heat exchanger 56, cold-side pump 62 pumps cold TES liquid 46 from end 52 through heat exchanger 56 while the heated compressed air flows in a separate fluid path therethrough. Compression path 28 is thus routed such that heat exchanger 54 is positioned on compression path 28 between low pressure compressor 22 and high pressure compressor 24 and such that heat exchanger 56 is positioned on compression path 28 downstream of the high pressure compressor 24 to cool air compressed by the high pressure compressor.

In one embodiment, heat exchangers 54, 56 are configured to remove the added heat such that the temperature of the compressed air cools back to a near-ambient temperature. In another embodiment, an intercooler 64 may be provided to remove extra heat from the compressed air in compression path 28 between heat exchanger 54 and high pressure compressor 24. The heat removed from the compressed air is transferred to the TES liquid 46 flowing through heat exchangers 54, 56, and the hot or heated TES liquid 46 is delivered to end 50 of containment vessel 44. Thermal separator 48 is configured to maintain a thermal separation between the hot TES liquid 46 and the cold TES liquid 46 in containment vessel 44 such that transference of the heat in the hot TES liquid 46 to the cold TES liquid 46 is minimized. In this manner, a larger amount of heat is available for heating cavern air as described below.

During the expansion or “discharging” stage/mode of operation of ACAES system 10, storage air from cavern 20 is brought into expansion path 34 through inlet 32 and provided to heat exchanger 56. To heat the compressed air in heat exchanger 56, hot-side pump 60 pumps hot TES liquid 46 from end 50 through heat exchanger 56 while the cooled compressed air from cavern 20 flows in a separate fluid path therethrough. High pressure turbine 38 then expands to the first pressure level and reduces a temperature of the air. The air is then routed through expansion path 34 to heat exchanger 54, where the air is again heated. To heat the compressed air in heat exchanger 54, hot-side pump 60 pumps hot TES liquid 46 from end 50 through heat exchanger 54 while the heated compressed air flows in a separate fluid path therethrough. The air then continues through expansion path 34 to low pressure compressor 22, where the air is expanded to a lower pressure level and to a lower temperature. In one embodiment, the air pressure is lowered to ambient pressure, and the temperature is lowered to a near-ambient temperature. The air then exits expansion path 34 into the ambient environment.

It is contemplated that motor-generator unit 12 may be connected to the electric power grid during, for instance, relatively less-expensive, off-peak, or low-demand hours such as at night to receive the power therefrom to operate compressor system 16 during the compression stage. Alternatively or additionally, the power may be derived from renewable sources such as wind, sun, tides, as examples, which often provide intermittent power that may be during less desirable low-demand hours. During the expansion mode of operation, the compressed air stored in cavern 20 is used to drive turbine system 18 and consequently motor-generator unit 12 in an electrical generation mode to produce additional electrical energy for the electric power grid during, for instance, high-energy needs and peak demand times.

It is recognized that embodiments of the invention are not limited to the examples described above. That is, a greater number of compressors and turbines and a greater number of TES units may be employed in an ACAES system, according to embodiments of the invention. The number of compressors desired to efficiently compress air to required operating and storing pressures may vary, as such pressures are highly dependent on the type and depth of air storage device/cavern 20. For example, a pressure range of approximately 400 psi to 1000 psi has been found adequate for a salt dome and aquifer located at a depth of approximately 1500 feet. The number of compressors to be used in compressor system 16 is in part dependent on air pressure and the type of individual compressor stages used, as well as other factors.

Therefore, according to one embodiment of the invention, an adiabatic compressed air energy storage (ACAES) system includes a compressor system configured to compress air supplied thereto. The compressor system includes a plurality of compressors and a compressor conduit fluidly connecting the plurality of compressors together and having an air inlet and an air outlet. The ACAES system also includes an air storage unit connected to the air outlet of the compressor conduit and configured to store compressed air received from the compressor system, and a turbine system configured to expand compressed air supplied thereto from the air storage unit. The turbine system includes a plurality of turbines and a turbine conduit fluidly connecting the plurality of turbines together and having an air inlet and an air outlet. The ACAES system further includes a thermal energy storage (TES) system configured to remove thermal energy from compressed air passing through the compressor conduit and to return thermal energy to air passing through the turbine conduit. The TES system includes a container, a plurality of heat exchangers, a liquid TES medium conduit system fluidly coupling the container to the plurality of heat exchangers, and a liquid TES medium stored within the container. The TES system also includes a plurality of pumps coupled to the liquid TES medium conduit system and configured to transport the liquid TES medium between the plurality of heat exchangers and the container, and a thermal separation system positioned within the container configured to thermally isolate a first portion of the liquid TES medium at a lower temperature from a second portion of the liquid TES medium at a higher temperature.

In accordance with another embodiment of the invention, a method for adiabatic compressed air energy storage (ACAES) includes supplying air to a compressor system, the compressor system including a plurality of compressor units fluidly connected by a compressor conduit. The method also includes compressing the air in the compressor system during a compression stage and storing the compressed air in a compressed air storage unit. The method also includes supplying the compressed air from the compressed air storage unit to a turbine system, the turbine system including a plurality of turbine units fluidly connected by a turbine conduit and expanding the air in the turbine system during an expansion stage. The method further includes, during each of the compression stage and the expansion stage, passing the air through a liquid thermal energy storage (TES) system coupled to each of the compressor conduit and the turbine conduit, the liquid TES system including a liquid storage volume, a plurality of heat exchangers fluidly coupled to the liquid storage volume, and a thermal separation unit configured to thermally isolate a liquid in the liquid storage volume on a first side of the thermal separation unit from a liquid in the liquid storage volume on a second side of the thermal separation unit.

In accordance with yet another embodiment of the invention, an adiabatic compressed air energy storage (ACAES) system includes a compressor system configured to compress air supplied thereto, the compressor system including a plurality of compressors and a compressor conduit connecting the plurality of compressors and having an air inlet and an air outlet. The ACAES system also includes an air storage unit connected to the air outlet of the compressor conduit and configured to store compressed air received from the compressor system, and a turbine system configured to expand compressed air supplied thereto from the air storage unit. The turbine system includes a plurality of turbines and a turbine conduit connecting the plurality of turbines and having an air inlet and an air outlet. The ACAES system further includes a liquid thermal energy storage (TES) system comprising a TES liquid configured to remove thermal energy from compressed air passing through the compressor conduit and to return thermal energy to air passing through the turbine conduit, the liquid TES system further including a storage volume configured to store the TES liquid, a plurality of heat exchangers fluidly coupled to the storage volume, and a thermal separator positioned within the container and configured to thermally separate a hot volume of the TES liquid from a cold volume of the TES liquid within the storage volume.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An adiabatic compressed air energy storage (ACAES) system comprising:
a compressor system configured to compress air supplied thereto, the compressor system comprising:
a plurality of compressors; and
a compressor conduit fluidly connecting the plurality of compressors together and having an air inlet and an air outlet;
an air storage unit connected to the air outlet of the compressor conduit and configured to store compressed air received from the compressor system;
a turbine system configured to expand compressed air supplied thereto from the air storage unit, the turbine system comprising:
a plurality of turbines; and
a turbine conduit fluidly connecting the plurality of turbines together and having an air inlet and an air outlet; and
a thermal energy storage (TES) system configured to remove thermal energy from compressed air passing through the compressor conduit and to return thermal energy to air passing through the turbine conduit, the TES system comprising:
a container;
a plurality of heat exchangers;
a liquid TES medium conduit system fluidly coupling the container to the plurality of heat exchangers;
a liquid TES medium stored within the container;
a plurality of pumps coupled to the liquid TES medium conduit system and configured to transport the liquid TES medium between the plurality of heat exchangers and the container; and
a thermal separation system positioned within the container configured to thermally isolate a first portion of the liquid TES medium at a lower temperature from a second portion of the liquid TES medium at a higher temperature.

2. The ACAES system of claim 1 wherein the thermal separation system comprises a floating separator piston configured to vary its position within the container according to the amount of liquid TES medium at the first temperature within the container.

3. The ACAES system of claim 1 wherein the thermal separation system comprises a medium positioned at a fixed location within the container.

4. The ACAES system of claim 3 wherein the thermal separation system comprises one of concrete, rocks, bricks, and metal.

5. The ACAES system of claim 1 wherein the liquid TES medium conduit system fluidly couples the plurality of heat exchangers together in a parallel mode.

6. The ACAES system of claim 1 further comprising:
a first pump fluidly coupled to the liquid TES medium conduit system and configured to convey a quantity of the liquid TES medium within the container and on a first side of the thermal separation system to the plurality of heat exchangers; and
a second pump fluidly coupled to the liquid TES medium conduit system and configured to convey a quantity of the liquid TES medium within the container and on a second side of the thermal separation system to the plurality of heat exchangers.

7. The ACAES system of claim 1 wherein:
the plurality of compressors comprises a low pressure compressor and a high pressure compressor;
the plurality of turbines comprises a low pressure turbine and a high pressure turbine; and
the plurality of heat exchangers comprises:
a first heat exchanger connected to the compressor conduit between the low pressure compressor and the high pressure compressor and connected to the turbine conduit between the low pressure turbine and the high pressure turbine; and
a second heat exchanger connected to the compressor conduit between the high pressure compressor and the air storage unit and connected to the turbine conduit between the high pressure turbine and the air storage unit.

8. The ACAES system of claim 7 wherein the compressor conduit is arranged to pass air at a first pressure through the first heat exchanger and to subsequently pass air at a second pressure through the second heat exchanger; and
wherein the turbine conduit is arranged to pass air at the second pressure through the second heat exchanger and to subsequently pass air at the first pressure through the first heat exchanger.

9. The ACAES system of claim 8 wherein the air at the first pressure comprises low pressure air and the air at the second pressure comprises high pressure air.

10. The ACAES system of claim 7 further comprising an intercooler connected to the compressor conduit between the first heat exchanger and the high pressure compressor.

11. The ACAES system of claim 1 further comprising:
a drive shaft coupleable to the compressor system and coupleable to the turbine system, the drive shaft configured to transfer rotational power to the compressor system and configured to receive rotational power from the turbine system; and
a motor-generator unit coupled to the drive shaft and configured to:
receive electrical energy from an external energy source and generate and transfer rotational power to the drive shaft; and
receive rotational power from the drive shaft and generate electrical energy in response thereto.

12. A method for adiabatic compressed air energy storage (ACAES) comprising:
supplying air to a compressor system, the compressor system including a plurality of compressor units fluidly connected by a compressor conduit;
compressing the air in the compressor system during a compression stage;
storing the compressed air in a compressed air storage unit;
supplying the compressed air from the compressed air storage unit to a turbine system, the turbine system including a plurality of turbine units fluidly connected by a turbine conduit;
expanding the air in the turbine system during an expansion stage; and
during each of the compression stage and the expansion stage, passing the air through a liquid thermal energy storage (TES) system coupled to each of the compressor conduit and the turbine conduit, the liquid TES system comprising:
a liquid storage volume;
a plurality of heat exchangers fluidly coupled to the liquid storage volume; and
a thermal separation unit configured to thermally isolate a liquid in the liquid storage volume on a first side of the thermal separation unit from a liquid in the liquid storage volume on a second side of the thermal separation unit.

13. The method of claim 12 further comprising:
pumping the liquid in the liquid storage volume on the first side of the thermal separation unit through the plurality of heat exchangers in a parallel mode during the compression stage to remove heat from the air passing through the compressor conduit; and
pumping the liquid in the liquid storage volume on the second side of the thermal separation unit through the plurality of heat exchangers in a parallel mode during the expansion stage to add heat to the air passing through the turbine conduit.

14. The method of claim 12 wherein passing the air through the plurality of TES units comprises:
passing the air through a first heat exchanger of the plurality of heat exchangers and subsequently passing the air through a second heat exchanger of the plurality of heat exchangers when passing the air through the compressor conduit such that low pressure air passes through the first heat exchanger and high pressure air passes through the second heat exchanger; and
passing the air through the second heat exchanger and subsequently passing the air through the first heat exchanger when passing the air through the turbine conduit such that high pressure air passes through the second heat exchanger and low pressure air passes through the first heat exchanger.

15. An adiabatic compressed air energy storage (ACAES) system comprising:
a compressor system configured to compress air supplied thereto, the compressor system comprising:
a plurality of compressors; and
a compressor conduit connecting the plurality of compressors and having an air inlet and an air outlet;
an air storage unit connected to the air outlet of the compressor conduit and configured to store compressed air received from the compressor system;
a turbine system configured to expand compressed air supplied thereto from the air storage unit, the turbine system comprising:
a plurality of turbines; and
a turbine conduit connecting the plurality of turbines and having an air inlet and an air outlet; and
a liquid thermal energy storage (TES) system comprising a TES liquid configured to remove thermal energy from compressed air passing through the compressor conduit and to return thermal energy to air passing through the turbine conduit, the liquid TES system further comprising:
a storage volume configured to store the TES liquid;
a plurality of heat exchangers fluidly coupled to the storage volume; and
a thermal separator positioned within the container and configured to thermally separate a hot volume of the TES liquid from a cold volume of the TES liquid within the storage volume.

16. The ACAES system of claim 15 wherein the thermal separator comprises a floating piston configured to float on the amount of the cold volume of the TES liquid within the container.

17. The ACAES system of claim 15 wherein the thermal separator comprises a fixed position medium within the container comprising one of concrete, rocks, bricks, and metal.

18. The ACAES system of claim 15 wherein the TES system further comprises a TES conduit system fluidly coupling the plurality of heat exchangers to the storage volume, wherein the TES conduit system further couples the plurality of heat exchangers together in a parallel mode.

19. The ACAES system of claim 18 wherein the TES conduit system further comprises:
a first pump configured to convey a quantity of the hot volume of the TES liquid from the container to the plurality of heat exchangers; and
a second pump configured to convey a quantity of the cold volume of the TES liquid from the container to the plurality of heat exchangers.

20. The ACAES system of claim 15 wherein:
the plurality of compressors comprises a low pressure compressor and a high pressure compressor;
the plurality of turbines comprises a low pressure turbine and a high pressure turbine;
the plurality of heat exchangers comprises:
a first heat exchanger fluidly coupled to the compressor conduit between the low pressure compressor and the high pressure compressor and fluidly coupled to the turbine conduit between the low pressure turbine and the high pressure turbine;
a second heat exchanger fluidly coupled to the compressor conduit between the high pressure compressor and the air storage unit and fluidly coupled to the turbine conduit between the high pressure turbine and the air storage unit;
the compressor conduit is arranged to pass air at a first pressure through the first heat exchanger and to subsequently pass air at a second pressure through the second heat exchanger; and
the turbine conduit is arranged to pass air at the second pressure through the second heat exchanger and to subsequently pass air at the first pressure through the first heat exchanger.
